(19) United States
(12) Patent Application Publication
(10) Pub. No.: US 2004/0033192 A1
(43) Pub. Date: Feb. 19, 2004

(54) Process for eliminating sulphur from a feed containing hydrogen sulfide and benzene, toluene and/or xylenes

(75) Inventors: Christophe Nedez, Salindres (FR); Jean-Francois Chapat, Salindres (FR); Jean-Louis Ray, Neuilly Sur Seine (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: Institute Francais du Petrole, Rueil Malmaison Cedex (FR)

(21) Appl. No.: 10/452,939

(22) Filed: Jun. 3, 2003

(30) Foreign Application Priority Data
Jun. 3, 2002 (FR) 02/06.772

(51) Int. Cl. B01D 53/50

(52) U.S. Cl. 423/574.1

(57) ABSTRACT

A process is described for eliminating sulphur from a feed containing hydrogen sulphide, sulphur dioxide, carbon oxysulphide and/or carbon sulphide and a minimal quantity of benzene, toluene and/or xylenes in at least one reaction zone containing a catalyst, and recovering elemental sulphur and an effluent that is at least partially free of sulphur, the process being characterized in that the catalyst used is at least one catalyst containing a support comprising at least one compound selected from de group formed by alumina, titanium oxide and zirconia, the support further comprising at least one doping element selected from the group formed by iron, cobalt, nickel, copper and vanadium.

The invention relates to a process for eliminating sulphur from a feed containing hydrogen sulphide and minimal traces of benzene, toluene and/or xylenes (BTX).

In particular, it is applicable to feeds containing up to 50000 ppm (volume) of BTX and preferably between 50 and 5000 ppm.

Natural gas, refinery gases, gases from coal transformation etc can contain H₂S in varying quantities. For environmental and safety reasons, it is usually necessary to transform the H₂S into an inert compound that also has added value, for example elemental sulphur.

A standard process used on an industrial scale is the Claus process. After separation by absorption carried out with amines, a heat treatment is carried out on the acid gas obtained, in the presence of an air makeup, at a temperature that is generally in the range 900° C. to 1300° C. Reaction (1) is carried out so as to aim for a mole ratio of 2 between the H₂S and the SO₂ at the end of the treatment.

H₂S+3/2 O₂→H₂O+SO₂ (1)

At the same time, about 70% of the sulphur-containing compounds is transformed into elemental sulphur Sₓ. The presence of hydrocarbons and CO₂ in the gas to be treated can cause the formation of by-products such as COS and CS₂.

During a second step, which is catalytic, transformation of all of the sulphur-containing compounds present into sulphur is continued, in accordance with the Claus reaction (2) and hydrolysis reactions (3) and (4), in reactors placed in series, usually 2 or 3 in number.

2H₂S+SO₂→3/x Sₓ+2H₂O (2)

CS₂+2H₂O→CO₂+2H₂S (3)

COS+H₂O→CO₂+H₂S (4)

A lower discharge of toxic effluents is thus directly linked to the use of efficient catalysts for converting H₂S, COS and CS₂.

Hydrocarbons are sometimes directly encountered in Claus reactors. They may, for example, derive from the acid gas being partially diverted in the direction of the inlet, for example for the first catalytic Claus reactor (R₁) without passing through the furnace: this scenario is routinely encountered when treating acid gas that is low in H₂S. The hydrocarbons then present in R₁ are constituted by a mixture, but the following are usually present: benzene, toluene, xylenes (hence the acronym BTX).

The skilled person is well aware of this situation and in particular its damaging consequences on the performance and service life of Claus catalysts. By way of illustration, in practical industrial cases, it has already been observed that this service life could be divided by more than ten compared with a comparable treatment carried out in the absence of BTX. Such deactivation is caused by a side reaction on the surface of the catalyst which gives rise to the generation of aromatic sulphur-containing compounds, usually constituted by aromatic compounds and/or polyaromatic compounds containing one or more sulphur atoms.

The present invention concerns at least one catalyst, in particular for the treatment of gases containing H₂S and the application of said catalyst or an optimized combination of catalysts that can very effectively resist accelerated ageing caused by the presence of hydrocarbons such as BTX. The overall performance of the sulphur recovery process is thus improved compared with current processes.

More precisely, the invention concerns a process for eliminating at least a portion of the sulphur in a feed containing hydrogen sulphide, sulphur dioxide, carbon oxysulphide and/or carbon sulphide and a minimal quantity of benzene, toluene and/or xylenes in at least one reaction zone containing a catalyst, and recovering elemental sulphur and an effluent that is at least partially free of sulphur, the process being characterized in that the catalyst used is at least one catalyst containing a support comprising at least one compound selected from the group formed by alumina, titanium oxide and zirconia, the support further comprising at least one doping element selected from the group formed by iron, cobalt, nickel, copper and vanadium.

The formulations claimed in the present application correspond to an alumina, titanium oxide or zirconia support modified by one or more doping elements. Doping is provided by at least one element included in the following list: Fe, Co, Ni, Cu, V. The total mass content of doping element(s) will be in the range 0.1% to 60%, preferably in the range 0.5% to 40%, more preferably in the range 0.5% to 20%, or even in the range 1% to 10% with respect to the total catalyst mass. Iron is the preferred doping element of the invention. The support can also be constituted by a combination of alumina, titanium oxide and/or zirconia.

In a particular implementation of the invention, the doping element is accompanied by one or more co-dopants. The co-dopant is an alkali metal, an alkaline-earth metal or a rare earth, or a combination of a plurality of said constituents. In this particular case, the total mass content of co-dopants is in the range 0.5% to 40%, advantageously in the range 1% to 30%, and preferably in the range 1% to 15% with respect to the total catalyst. The most routinely used co-dopant is calcium in the form of the sulphate.

The rare earth is selected from the group formed by lanthanum, cerium, praseodymium, neodymium, promethium, samarium, europium, gadolinium, terbium, dysprosium, holmium, erbium, thulium, ytterbium, yttrium and lutetium. Preferably, lanthanum and cerium are used.

The catalyst can be in any known form: powder, beads, extrudates, a monolith, or crushed material, for example. Two preferred forms of the invention are the extrudate, whether cylindrical or polylobed, and beads.

When forming by mixing followed by extrusion, the cross section of the extrudate is advantageously in the range 0.5 to 8 mm, preferably in the range 0.8 to 5 mm.

Regarding alumina, the alumina powder used as the starting material for preparing the composition of the invention will be obtained by conventional processes such as the precipitation or gel process, and rapid dehydration of an alumina hydrate such as hydrargillite.

When using alumina beads, they can be produced by drop coagulation of a suspension or an aqueous dispersion of alumina or of a solution of a basic aluminium salt in the form of an emulsion constituted by an organic phase, an aqueous phase and a surfactant or an emulsifying agent.

Alumina beads can also be obtained by agglomerating alumina powder using a rotary technique such as a bowl granulator or a rotary drum. Beads with controlled dimensions and pore distributions can be obtained, usually generated during the agglomeration step.

Alumina extrudates can be obtained by mixing followed by extrusion of an alumina-based material, said material possibly being produced by rapid dehydration of hydragillite and/or precipitation of one or more alumina gels. The alumina can also be formed as pellets.

Following forming, the alumina can undergo different operations to improve its mechanical properties, such as maturing by keeping them in an atmosphere with a controlled humidity followed by calcining then optional impregnation of the alumina with a solution of one or more mineral and/or organic acids, and a hydrothermal treatment in a confined atmosphere. In general, after the treatments, the alumina is dried and calcined.

When forming by mixing followed by extrusion, the cross section of the extrudate is advantageously in the range 0.5 to 5 mm, preferably in the range 0.7 to 3 mm. When producing beads, the bead diameter is in general in the range 0.8 to 15 mm, advantageously in the range 1 to 8 mm, and preferably in the range 2 to 7 mm.

The doping or co-doping elements can be deposited using any method known to the skilled person.

As an example, it/they can be deposited by impregnating the prepared support with the elements to be added or precursors of said elements (nitrates, sulphates, or carbonates, for example) or by mixing the elements or precursors of said elements with the support during or before forming the latter. The doping or co-doping elements can also be deposited in the support by co-precipitation.

When depositing by impregnation, this is carried out in a known manner by bringing the support into contact with one or more solutions, one or more sols and/or one or more gels comprising at least one element in the form of the oxide or a salt or a precursor thereof. The operation is generally carried out by immersing the support in a predetermined volume of solution of at least one precursor of at least one doping or co-doping element. In a preferred mode, the doping or co-doping elements are supplied by dry impregnation. In an alternative, the elements can be supplied by excess impregnation, said excess solution then being evacuated by draining.

The compounds deposited on the support can be selected from organic compounds, preferably oxalates and formates, and/or inorganic compounds. They are preferably selected from inorganic compounds (sulphates, nitrates, chlorides or oxychlorides, for example).

The composition employed in the process of the invention is obtained by drying and calcining the support on which said compound has been deposited. After deposition, the support can be calcined at a temperature that is generally more than 150° C., preferably in the range 250° C. to 800° C. In general, the calcining temperature, after deposition on the support, does not exceed 1200° C.

In a preferred implementation of the invention, the catalyst obtained has a specific surface area of more than 10 m²/g, advantageously more than 30 m²/g, for example 50-400 m²/g.

The catalyst can completely fill one or more Claus reactors, or only a part thereof. In the latter case, it is located at the top of the reactor, as the gas to be treated in a Claus reactor is traditionally supplied from top to bottom.

More precisely, the reactor can comprise at least one bed containing said catalyst disposed upstream of a further catalytic mass, termed A, so that it acts as a protective layer for said catalytic mass, the volume of the bed representing 1% to 70% of the volume of the reactor.

When the support used as a catalytic mass is titanium oxide, it can advantageously comprise at least one sulphate of an alkaline-earth metal selected from the group formed by calcium, barium, strontium and magnesium. Preferably, the alkaline-earth metal is calcium.

In a variation, the reactor can comprise at least two beds of catalyst, in series, with a different composition, each occupying an equal or different volume of the reaction zone, as a protective layer for mass A.

In accordance with one characteristic of the invention, the volume of catalyst represents between 1% and 70% of the total volume of catalyst and catalytic mass A placed in the reactors, advantageously between 5% and 60%, and preferably between 10% and 50%. The aim is to act as a protective layer for catalytic masses A placed downstream (TiO₂, for example). It should be noted that the catalyst supplements the performance in carrying out the reactions (2), (3) and (4).

In one implementation, the reaction zone comprises an alternating series of a bed of catalyst and a bed of catalytic mass A.

In a preferred implementation, the reaction zone can comprise two reactors in series, each containing a bed of catalyst followed by a bed of catalytic mass A, a sulphur condensation zone optionally being interposed between thetwo reactors.

By condensing the sulphur and recovering it, sulphur vapour in the second reactor is avoided and the equilibrium of the Claus reaction is not perturbed.

The general operating conditions of the process are as follows:

HSV (h⁻¹)=100 to 3000, preferably 500 to 1500;

T=200-380° C., preferably 250-300° C;

P=0.02 to 0.2 MPa relative, preferably 0.05 to 0.1 MPa.

The invention will now be illustrated by the following examples.

### EXAMPLES

CR-3S is the trade name for a Claus alumina sold by Axens. It is in the form of beads with a diameter in the range 3.15 to 6.3 mm.

The catalytic mass A was prepared as follows:

A suspension of calcium hydroxide was added to a suspension of titanium oxide obtained by hydrolysis and filtration in the conventional ilmenite sulphuric attack method, to neutralize all the sulphates present. Once completed, the suspension was dried at 150° C. for one hour. The powder was then mixed in the presence of water and nitric acid. The paste produced was extruded through a die to obtain extrudates with a cylindrical shape. After drying at 120° C. and calcining at 450° C., the extrudates had a diameter of 3.5 mm, a specific surface area of 116 m²/g and a total pore volume of 36 ml/100 g. The TiO₂ content was 88% with a CaSO₄ content of 11%, and the loss on ignition made the balance up to 100%. The catalytic mass was termed A. Its Ca mass content (expressed as Ca) was 3%.

Catalyst B was produced by dry impregnation of an aqueous acidic solution of iron sulphate on A, followed by drying at 120° C. and calcining at 350° C. B then had an iron content (expressed as Fe) of 2%. B thus contained iron and calcium.

Catalyst C was produced by dry impregnation of an aqueous acidic solution of iron sulphate on CR-3S, followed by drying at 120° C. and calcining at 350° C. C then had an iron content (expressed as Fe) of 2%.

Catalyst D was produced by dry impregnation of an aqueous nickel nitrate solution on CR-3S, followed by drying at 120° C. and calcining at 350° C. D then had a nickel content (expressed as Ni) of 4%.

Catalyst E was produced by dry impregnation of an aqueous copper nitrate solution on CR-3S, followed by drying at 120° C. and calcining at 350° C. E then had a copper content (expressed as Cu) of 6%.

B, C, D and E satisfied the criteria of the invention.

The catalysts or catalyst combinations were tested over 100 hours under the conditions of the first Claus reactor (R₁) with a feed containing, by volume: 4.9% H2S, 3.1% SO₂, 0.83% COS, 0.59% CS₂, 21.6% CO₂, 2.3% CO, 1.3% H_{2, 22.8}% H₂O, 200 ppm O₂, N₂ (qsp). Certain experiments were carried out with this, others in the permanent presence of an additional 2000 ppm by volume of toluene. The hourly space velocity HSV was 1300 h⁻¹ in all cases. The pressure was close to atmospheric pressure; the temperature was kept at 270° C. The crucial reaction, as it is the most difficult to control, is the CS₂ hydrolysis reaction (3) in reactor R₁: it thus acted as the reference reaction.

The results obtained are summarized in Table I which shows the proportions (%) by volume of the reactor occupied by the various catalysts acting as a protective layer then the proportions by volume of the reactor occupied by the catalytic mass.

In the absence of BTX, a reactor 100% filled with catalytic mass A provided the best performance for sulphur recovery. In contrast, under conditions for possible formation of aromatic sulphur-containing compounds (i.e., in the presence of toluene), A was the worst solution due to rapid deactivation. In contrast, the arrangements in accordance with the invention (application of B, C, D and E as a protective layer for A) provided substantially superior results, while protecting A with an alumina appeared to be ineffective.

Catalyst B′ comprised, as the support, pure titanium oxide resulting from hydrolysis of a titanium alkoxide then mixing followed by extrusion, drying at 120° C. then calcining at 450° C.

TABLE I

| | |
|---|---|
| No | Toluene |

| Catalysts | toluene | 1% | 2000 ppm |
|---|---|---|---|
| 100% A | 82% | | 44% |
| 20% CR-3S then 80% A | 74% | | |
| 40% B then 60% A | | 65% | |
| 100% A | | 20% | |
| 100% B | | | 70% |
| 30% C then 70% A | 74% | | 70% |
| 30% D then 70% A | | | 64% |
| 25% C then 75% A | | | 69% |
| 25% E then 75% A | 74% | | 65% |
| 40% B then 60% A | 77% | | 72% |
| 40% B′ then 60% A | | | 67% |
| 20% B then 10% E then | 77% | | 71% |
| 70% A | | | |

### Other Examples

Catalysts Doped With Cobalt or Vanadium:

The preparation of catalyst D was repeated, but instead of introducing nickel, cobalt nitrate or vanadium nitrate was introduced to obtain a catalyst doped with cobalt and a catalyst doped with vanadium respectively. These two catalysts produced substantially the same result as catalyst D doped with nickel, when used as a protective layer for the titanium catalytic mass A, said protective layer occupying 30% of the reactor volume.

Influence of Zirconia Support on Catalyst:

Hydrated zirconium oxide was obtained by sodium hydroxide treatment then washing the basic zirconium sulphate with nitric acid and water, in the following proportions: 75% of powder, 10% of nitric acid and 15% water. Said powder was then mixed for one hour and extruded. The extrudates were then dried at 120° C. for 2 hours and calcined at 450° C. for two hours. The catalyst obtained had a diameter of 3.5 mm, with a specific surface area of 91 m²/g and a total pore volume of 34 ml/l00 g.

A Fe/ZrO₂ catalyst was prepared by dry impregnation of an aqueous acidic solution of iron sulphate onto synthesized zirconia followed by drying at 120° C. and calcining at 350° C. The catalyst then had an iron content (expressed as Fe) of 4% by weight.

The sequence: 30% of the volume of the reactor contained 4% of Fe/ZrO₂ then 70% of the volume of the reactor contained A, under the experimental conditions described, in the presence of 2000 ppm of toluene, resulted in a conversion of 76% CS₂ after 100 hours of reaction.

Influence of Zirconia as Catalytic Mass:

Zirconia synthesized with or without calcium sulphate was disposed as the catalytic mass in the Claus reactor using the following sequence: 30% of the reactor volume contained the catalyst C (Al₂O₃-4% Fe) then 70% of the reactor volume contained the zirconia catalytic mass, which resulted in a conversion of 78% of CS₂ in the presence of 2000 ppm of toluene under the same experimental conditions as those described in the preceding examples.

The preceding examples can be repeated with similar success by substituting the generically or specifically described reactants and/or operating conditions of this invention for those used in the preceding examples.

The entire disclosures of all applications, patents and publications, cited herein and of corresponding French application No. 02/06.772, filed Jun. 3, 2002 is incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. A process for eliminating sulphur from a feed containing hydrogen sulphide, sulphur dioxide, carbon oxysulphide and/or carbon sulphide and a minimal quantity of benzene, toluene and/or xylenes in at least one reaction zone containing a catalyst, and recovering elemental sulphur and an effluent that is at least partially free of sulphur, the process being characterized in that the catalyst used is at least one catalyst containing a support comprising at least one compound selected from the group formed by alumina, titanium oxide and zirconia, the support further comprising at least one doping element selected from the group formed by iron, cobalt, nickel, copper and vanadium.

2. A process according to claim 1, in which the support further comprises at least one co-doping element selected from the group formed by an alkali metal, an alkaline-earth metal and a rare earth.

3. A process according to claim 1 or claim 2, in which the doping element of the support, used alone or as a mixture, has a weight content, in the range 0. 1% to 60% of the total catalyst mass.

4. A process according to one of claims 1 to 3, in which the weight content of the co-doping element, used alone or as a mixture, represents 0.5% to 40%- of the total catalyst mass.

5. A process according to one of claims 1 to 4, in which the operating conditions are as follows:

| | |
|---|---|
| temperature | 200-380° C., preferably 250-300° C.; |
| pressure | 0.02 to 0.2 MPa relative, preferably 0.05 to 0.1 MPa; |
| HSV (h⁻¹) | 100-3000, preferably 500 to 1500. |

6. A process according to one of claims 1 to 5, in which the reaction zone comprises at least one bed containing said catalyst disposed upstream of a further catalytic mass acting as a protective layer for said catalytic mass, the volume of the bed representing 1% to 70% by volume of the reaction zone.

7. A process according to one of claims 1 to 6, in which the reaction zone comprises at least two catalyst beds, in series, with different compositions and each occupying a volume of the reaction zone that can be equal or different.

8. A process according to one of claims 1 to 7, in which the catalyst is in the form of a powder, beads, extrudates, a monolith or crushed material, preferably in the form of beads or extrudates.

9. A process according to one of claims 6 to 8, in which the catalytic mass is titanium oxide comprising a calcium salt in the reaction zone, the mass being disposed in the downstream portion.

10. A process according to one of claims 6 to 8, in which the reaction zone comprises an alternating series of a catalyst bed and a bed of catalytic mass A.

11. A process according to one of claims 6 to 8, in which the reaction zone comprises two reactors in series, each containing a bed of catalyst followed by a bed of catalytic mass A, a sulphur condensation zone optionally being interposed between the two reactors.
